(19) United States
(12) Patent Application Publication
(10) Pub. No.: US 2006/0055775 A1
(43) Pub. Date: Mar. 16, 2006

(54) SYSTEM AND METHOD FOR PROVIDING IMAGE SERVICE USING TELEMATICS SYSTEM

(76) Inventor: SEONG TAEG NOU, ICHEON-SHI KYUNGKI-DO (KR)

Correspondence Address: IPLA P.A., 3580 WILSHIRE BLVD., 17TH FLOOR, LOS ANGELES, CA, 90010, US

(21) Appl. No.: 11/161,924

(22) Filed: Aug. 22, 2005

(30) Foreign Application Priority Data
Sep. 16, 2004 (KR) 10-2004-0074037

(51) Int. Cl. H04N 7/18

(52) U.S. Cl. 348/118

(57) ABSTRACT

A system and method for providing an image service using a telematics system is provided. The system includes: a first communication terminal for capturing an image, generating position information, and transmitting image information; a service providing center for receiving the image information, detecting the position information and the image, storing the image based on the position information by the area, and transmitting the corresponding specific area image; and a second communication terminal for generating and transmitting the image service request signal, and receiving and displaying the image from the service providing center in response to the image service request signal.

### BACKGROUND OF THE INVENTION

1. Field of the Invention

The present invention relates to a telematics system, and more particularly, to a system and method for providing an image service using a telematics system.

2. Description of the Related Art

In recent years, one of technologies attracting attention is a telematics system. The telematics system detects occurrence of vehicle accident or theft, guides a vehicle running path, and provides a vehicle driver with a variety of other information using a mobile communication method and a position tracing method associated with Internet. In other words, the telematics system provides information through a vehicle based on a Global Positioning System (Hereinafter, referred to as “GPS”) using a mobile communication system and a GPS satellite. Accordingly, the telematics system is expected to provide a variety of mobile communication services, such as traffic information, countermeasure to an emergency situation, remote vehicle diagnosis, the use of Internet (for example, financial transaction, provision of news, and transmission and reception of e-mail), using the GPS, a wireless communication network and an Internet network.

One of the reasons why the telematics system attracts attention is that it creates a newly conceptive value added service, which is able to maximize a synergy effect by merging an automobile industry with an Information Telecommunication (IT) industry.

Owing to this point, the telematics system for a telematics service is being actively researched and developed. If the telematics service is realized, a car can be reconstructed through a wire or wireless communication and broadcasting network, using Internet, which is a third space following an office space and a home space, and can be associated with home networking and office automation through a hetero communication and broadcasting network and an intelligent terminal, thereby providing a service for home and office even to the car without interruption.

Together with the spotlight of a telematics technology and the development of the telematics system, a variety of service contents satisfying a user's desire are being required.

### SUMMARY OF THE INVENTION

Accordingly, the present invention is directed to a system and method for providing an image service using a telematics system that substantially overcomes one or more of the limitations and disadvantages of the conventional art.

An object of the present invention is to provide a system and method for providing an image service using a telematics system, in which the image service can be provided through a wire or wireless network by taking and collecting images of such as a traffic situation and a scene in driving, using the telematics system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for providing an image service using a telematics system, the system including: a first communication terminal for capturing an image using a camera, generating position information corresponding to a position of the captured image using a GPS (Global Positioning System), and transmitting image information including the position information and the captured image; a service providing center for receiving the image information, detecting the position information and the image from the received image information, storing the image based on the position information by the area, and upon reception of an image service request signal for requesting a specific area image of the stored images, transmitting the corresponding specific area image; and a second communication terminal for generating and transmitting the image service request signal, and receiving and displaying the image from the service providing center in response to the image service request signal.

In another aspect of the present invention, there is provided a method for providing an image service using a telematics system, the method including: in a first communication terminal, capturing an image using a camera, generating position information corresponding to a position of the captured image using a GPS (Global Positioning System), and transmitting image information including the position information and the captured image; in a service providing center, receiving the image information, detecting the position information and the image from the received image information, and storing the image based on the position information by an area; in a second communication terminal, generating and transmitting an image service request signal for requesting a specific area image of the stored images; in the service providing center, upon reception of the image service request signal requesting the specific area image of the stored images, transmitting the corresponding specific area image; and in the second communication terminal, receiving and displaying the image from the service providing center in response to the image service request signal.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a system for providing an image service using a telematics system according to the present invention;

FIG. 2 illustrates a construction of a telematics terminal according to the present invention;

FIG. 3 illustrates a construction of a service providing center according to the present invention;

FIG. 4 illustrates a flow chart of an image collecting and transmitting method of a telematics terminal in accordance with an exemplary embodiment of the present invention;

FIG. 5 illustrates a flow chart of an image processing method of a service providing center in accordance with an exemplary embodiment of the present invention;

FIG. 6 illustrates a flow chart of an image service providing method of a service providing center in accordance with the first exemplary embodiment of the present invention; and

FIG. 7 illustrates a flow chart of an image processing method of a service providing center in accordance with the second exemplary embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

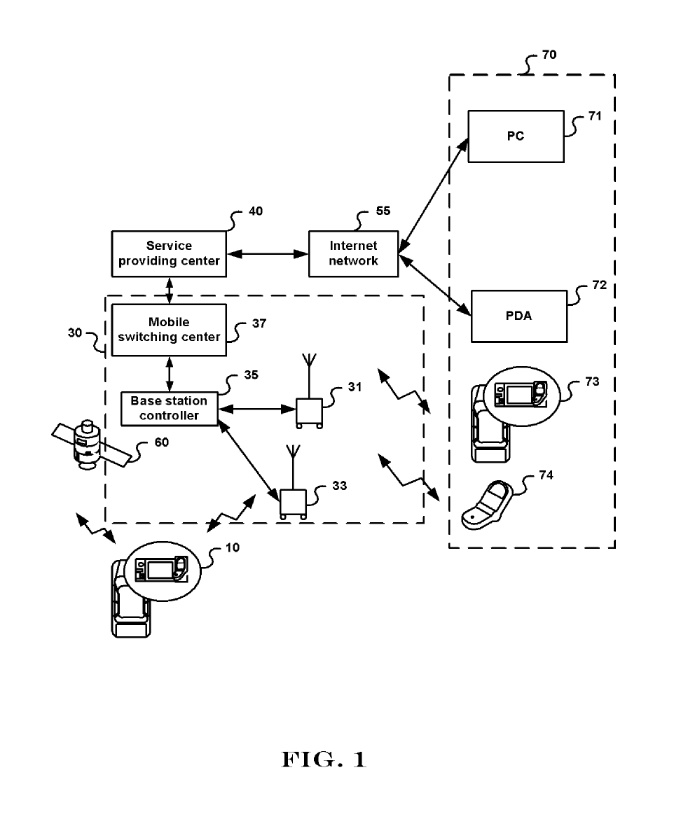

FIG. 1 illustrates a construction of a system for providing an image service using a telematics system in accordance with the present invention.

Referring to FIG. 1, the inventive image service providing system using the telematics system includes a telematics terminal 10, a mobile communication network 30, a service providing center 40, an Internet network 55 and a communication terminal 70.

The telematics terminal 10 receives position information from an artificial satellite 60, maps the received position information to a previously stored map data, and displays a car's position on a displaying device such as a Liquid Crystal Display (LCD). Namely, the telematics terminal 10 graphically displays a present position of a vehicle on the LCD using a GPS system.

Further, the telematics terminal 10 diagnoses a car status through a sensor connected to a car's interior or exterior, and displays information on the diagnosed car status on the displaying device. The telematics terminal 10 is connected with a communication terminal 10-1 so as to connect with the mobile communication network 30.

The telematics terminal 10 informs a driver of a present traffic situation by receiving traffic information from the mobile communication network 30 and displaying the received traffic information on the LCD.

The telematics terminal 10 takes an image by a predetermined event signal using cameras mounted inside and outside of the vehicle, and transmits position information traced in taking the image, and the image to the mobile communication network 30.

The service providing center 40 is wirelessly connected with the telematics terminal 10 through the mobile communication network 30, to receive the image and the position information from the telematics terminal 10 and store the image information based on the position information by an area. When the telematics terminal 10 receives an image service request signal through the Internet network 55 and the mobile communication network 30, it transmits a corresponding image to the Internet network 55 and the mobile communication network 30.

The communication terminal 70 may be a Personal Computer (PC) 71, a Personal Digital Assistant (PDA) 72, a telematics terminal 73, and a cellular phone 74.

The communication terminal 70 requests the service providing center 40 to provide an image of a specific area through the Internet network 55 and the mobile communication network 30, and receives and displays the image of the specific area.

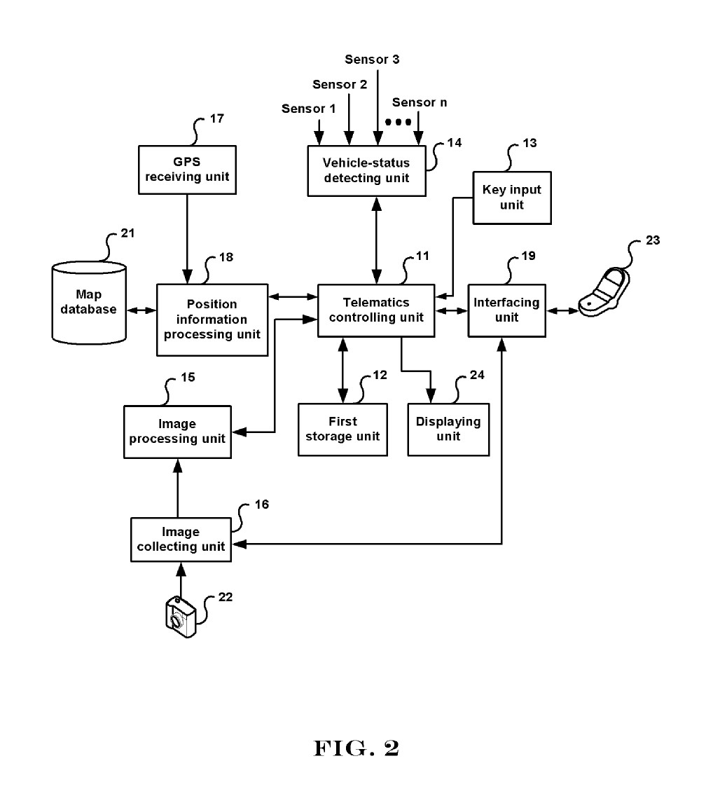

FIG. 2 illustrates a construction of a telematics terminal according to the present invention. A construction and an operation of the telematics terminal will be described with reference to FIG. 2 below.

The telematics terminal 10 includes a telematics controlling unit 11, a first storage unit 12, a key input unit 13, a vehicle-status detecting unit 14, an image processing unit 15, an image collecting unit 16, a GPS receiving unit 17, a position information processing unit 18, an interfacing unit 19, a map database 21, a digital camera 22, a mobile communication terminal 23, and a displaying unit 24.

The telematics controlling unit 11 controls a general operation of the telematics terminal 10. The first storage unit 12 includes a Read Only Memory (ROM) for storing a control program for controlling an operation of the telematics terminal 10, a Random Access Memory (RAM) for temporarily storing data generated during the execution of the control program, and a flash memory for user data such as an image storage time, the position information, and the image.

The key input unit 13 includes a plurality of numeric keys, function keys, mode keys, and end keys, and generates key data corresponding to the keys.

The vehicle-status detecting unit 14 detects a status signal of each car constituent component from a plurality of sensors disposed at interior and exterior parts of the vehicle, and transmits the detected status signal to the telematics controlling unit 11. The sensors can be exemplified as a collision sensor for sensing the collision at a front or rear of the car, an airbag sensor for sensing the activation of the airbag when a sensed value of the collision sensor is larger than a predetermined value, a sensor for checking an amount of car's oil, and a sensor for sensing the opening or closing of the window, the door, and the trunk. The telematics controlling unit 11 receives vehicle diagnostic information from the vehicle-status detecting unit 14, converts the vehicle diagnostic information into a graphic or text format, and displays the converted diagnostic information on the displaying unit 24.

The displaying unit 24 displays a variety of information, such as an operation mode and state of the telematics system and the car status, in the graphic or text format, under the control of the telematics controller 11. The displaying unit 24 can employ the LCD and the like.

A timer (not shown) counts and provides time information to the telematics controlling unit 11.

The interfacing unit 19 is connected with a Universal Asynchronous Receiver and Transmitter (UART)(not shown) of the wireless communication unit 23, and wirelessly connects the telematics terminal 10 with a base station 33 of FIG. 1.

The image collecting unit 16 receives and collects a plurality of images. A reference number 22 denotes the camera. The camera 22 is a digital camera. Only one camera is depicted in FIG. 2, but a plurality of cameras can be provided. Further, the image collecting unit 16 can be connected with a small-sized mobile digital camera using a jack connection unit (not shown).

The jack connection unit 120 employs a Universal Serial Bus (USB) or an IEEE1394. Capturing technique of image data through the USB (Universal Serial Bus) or the IEEE 1394 is well known in the art and therefore, its detailed description will be omitted.

The image collecting unit 16 respectively separates and collects the image information from a plurality of the cameras. The image processing unit 15 receives the image information from the image collecting unit 16, converts the received image information into a compressed format or a format being processed in the telematics controlling unit 11, and outputs the converted image information to the telematics controlling unit 11. The telematics controlling unit 11 receives and stores the image in the first storage unit 12.

The GPS receiving unit 17 receives a position information signal corresponding to a high-bandwidth wireless frequency transmitted from the artificial satellite 60, and detects the position information from the wireless signal. The map database 21 stores national map data. The position information processing unit 18 receives the position information from the GPS receiving unit 17 under the control of the telematics controlling unit 11, maps the received position information to the map data on a predetermined area where the vehicle equipped with the telematics terminal 10 is located based on the received position information, and outputs the mapped map data to the telematics controlling unit 11. Here, the telematics controlling unit 11 receives the map data mapped to the position information, displays the vehicle position on the displaying unit 24, and stores the vehicle position in the first storage unit 12.

The position information and the vehicle diagnostic information stored in the first storage unit 12 are periodically updated.

In case where the telematics controlling unit 11 receives an image service request signal from the key input unit 13, it captures the image through the camera 22, the image collecting unit 16, and the image processing unit 15, and stores the captured image in the first storage unit 12.

The position information, the vehicle diagnostic information, and the captured image information stored in the first storage unit 12 are wirelessly transmitted through the interfacing unit 19 and the mobile communication terminal 23.

The transmitted signal is transmitted to the service providing center 40, though mobile communication Network 30 which includes the wireless base station 33, a base station controller 35, and mobile switching center 37.

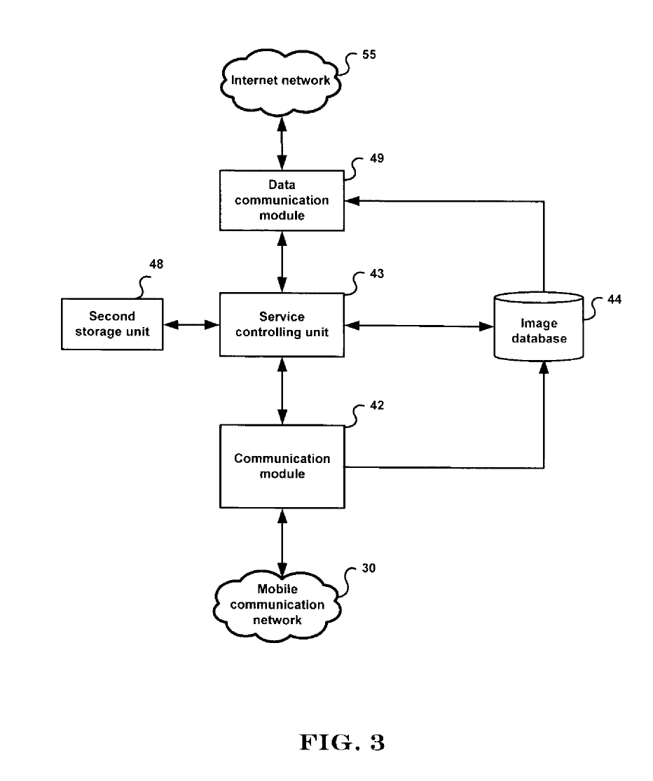

FIG. 3 illustrates a construction of the service providing center according to the present invention.

The construction of the service providing center will be explained with reference to FIG. 3 below.

The service providing center 40 includes a communication module 42, a service controlling unit 43, an image database, a second storage unit 28, and a data communication module 49.

The communication module 42 connects with the mobile communication network 30, and interfaces signals inputted/outputted through the wireless communication network 30.

The communication module 42 detects the position information from the image information received through the communication network 30, outputs the detected position information to the service controlling unit 43, and outputs the image information to the image database 44 under the control of the service controlling unit 43.

The second storage unit 48 includes a ROM for storing a control program for controlling an operation of the service providing center 40, and a RAM provisionally for storing a data generated during the execution of the control program. The image database 44 classifies and stores, by the area, the image inputted through the wireless communication network 30 under the control of the service controlling unit 43. The data communication module 49 interfaces the signal inputted/outputted through the Internet network 55. The service controlling unit 43 controls a general operation of the service providing center 40, receives the position information from the communication module 42, controls the communication module 42 to output the image to the image database 44, and controls the image database 44 to store the image based on the position information by the area.

Further, when the service controlling unit 43 receives an image service request signal for requesting the image of the specific area through the data communication module 49, it transmits the image of the specific area from the image database 44 to the Internet network 55 through the data communication module 49.

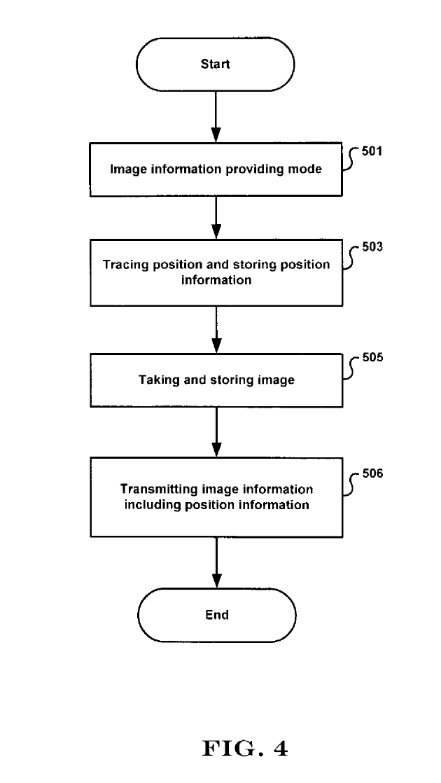

FIG. 4 illustrates a flow chart of an image collecting and transmitting method of the telematics terminal in accordance with an exemplary embodiment of the present invention.

Referring to FIGS. 2 to 4, the image collecting and transmitting method will be explained as follows.

The telematics controlling unit 11 controls an image providing mode (Step 501).

The image providing mode can be set by driver's pressing the function key of the key input unit 13 for providing the image, or can be periodically set using the time information inputted from the timer (not shown). If the image providing mode is set, the telematics controlling unit 11 controls the GPS receiving unit 17, the position information processing unit 16 and the map database 21, to trace the present position and store the traced position in the first storage unit 12 (Step 503).

After that, the telematics controlling unit 11 controls the image processing unit 15, to capture and store the image inputted from the camera 22 and the image collecting unit. The capturing of the image is performed until the driver presses the end key of the key input unit 13 or until a pre-stored image storage time lapses (Step 505). After that, the telematics controlling unit 11 transmits the image information, which is constituted of the position information and the image, to the base station 33 of the mobile communication network 30 through the interfacing unit 19 and the mobile communication terminal 23 (Step 506).

The above description has been made for a case where in the telematics controlling unit 11 transmits the image. However, the image can be also stored in the service providing center 40 through the mobile communication network 30 using the cellular phone or the PDA, which can capture the image.

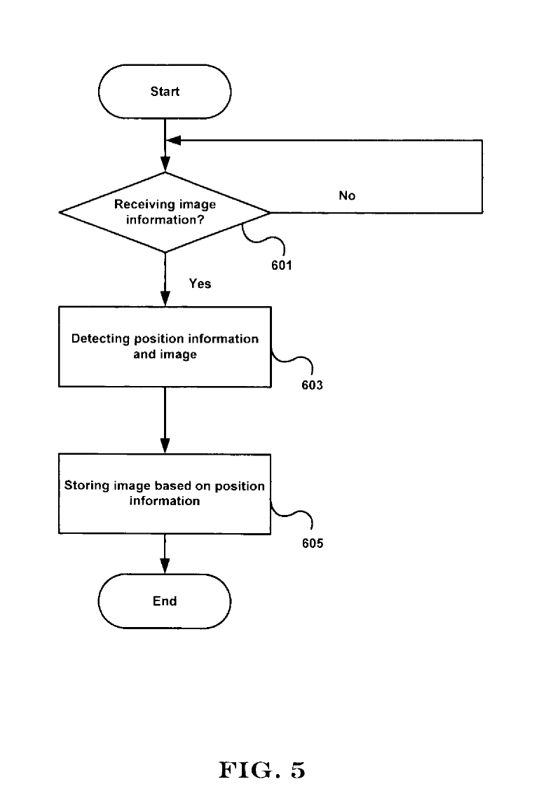

FIG. 5 illustrates a flow chart of an image processing method of the service providing center in accordance with an exemplary embodiment of the present invention.

The service controlling unit 43 checks whether or not the communication module 42 receives the image information (Step 601).

If it is checked that the image information is received through the mobile communication network 30 and the communication module 42, the position information and the image are detected from the image information (Step 603). After that, the area corresponding to the position information is searched, and the detected image is stored, together with the area information, in the storage region of the image database 44 for storing the area images (Step 605).

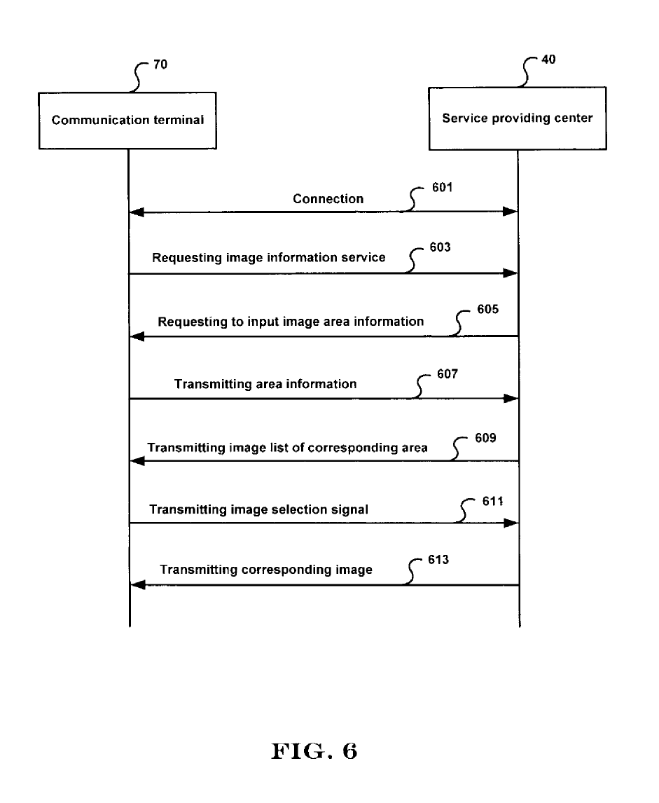

FIG. 6 illustrates a flow chart of the image service providing method of the service providing center in accordance with the first exemplary embodiment of the present invention. FIG. 6 illustrates a process of providing the stored images of FIGS. 4 and 5 when a request of the communication terminal 70 is received.

Referring to FIG. 6, the mobile communication terminal 70 is connected to the service providing center 40 through the Internet network 55 and the mobile communication network 30 (Step 601).

In other words, in the case that the communication terminal 70 is the cellular phone 74 and the telematics terminal 73, the cellular phone 74 and the telematics terminal 73 are connected with the service providing center 40 through the mobile communication network 30. In the case that the communication terminal 70 is the PC 71 and the PDA 72, the PC 71 and the PDA 72 is connected with the service providing center 40 through the Internet network 55.

In the case that the communication terminal 70 is connected to the service providing center 40 (Step 601), the communication terminal 70 transmits an image information service request signal to the service providing center 40 (Step 603).

When the service providing center 40 receives the image information service request signal (Step 603), it requests the communication terminal 70 to input an image information area (Step 605). When the communication terminal 70 is requested, it transmits the area information (Step 607). The area information may be “Yeoksamdong”, for example.

When the service providing center 40 receives the area information (Step 607), it transmits an image list of a corresponding area (Step 609).

The image list of the corresponding area may be a list of “1. Yeoksam-dong; 2. Yeoksam 1-dong; 3. Yeoksam station; 4. Intellectual Property Office”.

The communication terminal 70 receives the image list of the corresponding area (Step 609), selects any one of the areas of the list, and transmits an image selection signal to the service providing center 40 (Step 611).

The service providing center 40 transmits the selected image corresponding to the area to the communication terminal 70 (Step 613). The communication terminal 70 may also store or delete the received image.

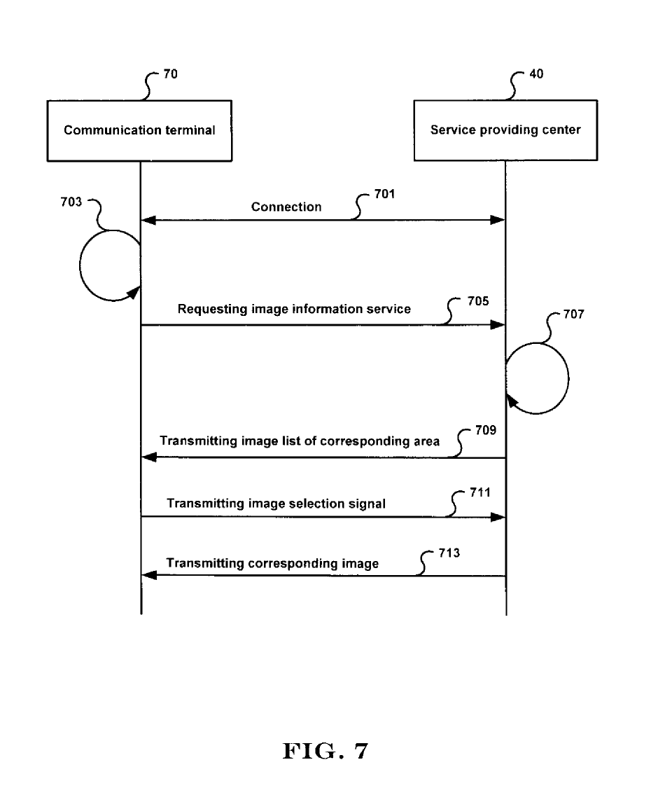

FIG. 7 illustrates a flow chart of the image processing method of the service providing center in accordance with the second exemplary embodiment of the present invention.

Referring to FIG. 7, the communication terminal 70 connects to the service providing center 40 through the Internet network 55 and the wireless communication network 30 (Step 701).

In the case that the communication terminal 70 is connected to the service providing center 40 (Step 701), the communication terminal 70 inputs the area information (Step 703), and transmits the image information service request signal including the area information to the service providing center 40 (Step 705).

When the service providing center 40 receives the image information service request signal (Step 705), it detects the area information from the image information service request signal (Step 707), and transmits the image list corresponding to the area information (Step 709).

The image list of corresponding area may be a list of “1. Yeoksam-dong; 2. Yeoksam 1-dong; 3. Yeoksam station; 4. Intellectual Property Office”.

The communication terminal 70 receives the picture list of the corresponding area (Step 709), selects any one of the areas of the list, and transmits an image selection signal to the service providing center 40 (Step 711).

The service providing center 40 transmits the selected image corresponding to the area to the communication terminal 70 (Step 713).

As described above, the present invention has an advantage in that the user using the communication terminal can easily receive and view the image of his/her desiring area all the way, and confirm the traffic situation of the desired area through the image, thereby avoiding a congested road.

Further, the present invention has an advantage in that since the user using the communication terminal can view the scene of his/her desiring area, his/her desire to view the scene can be satisfied even without a direct visit.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for providing an image service using a telematics system, the system comprising:
a first communication terminal for capturing an image using a camera, generating position information corresponding to a position of the captured image using a GPS (Global Positioning System), and transmitting image information including the position information and the captured image;
a service providing center for receiving the image information, detecting the position information and the image from the received image information, storing the image based on the position information by the area, and upon reception of an image service request signal for requesting a specific area image of the stored images, transmitting the corresponding specific area image; and
a second communication terminal for generating and transmitting the image service request signal, and receiving and displaying the image from the service providing center in response to the image service request signal.

2. The system according to claim 1, wherein the first communication terminal is a telematics device connected with the service providing center through a mobile communication network.

3. The system according to claim 1, wherein the first communication terminal is a cellular phone having a camera and connected with the service providing center through a mobile communication network.

4. The system according to claim 1, wherein the first communication terminal is a PDA (Personal Digital Assistant) having a camera and connected with the service providing center through a mobile communication network.

5. The system according to claim 1, wherein the second communication terminal is a telematics device connected with the service providing center through a mobile communication network.

6. The system according to claim 1, wherein the second communication terminal is a cellular phone having a camera and connected with the service providing center through a mobile communication network.

7. The system according to claim 1, wherein the second communication terminal is a PDA (Personal Digital Assistant) having a camera and connected with the service providing center through a mobile communication network.

8. The system according to claim 1, wherein the second communication terminal is a personal computer having a camera and connected with the service providing center through an Internet network.

9. The system according to claim 1, wherein the first communication terminal is a PDA (Personal Digital Assistant) having a camera and connected with the service providing center through an Internet network.

10. A method for providing an image service using a telematics system, the method comprising:
in a first communication terminal, capturing an image using a camera, generating position information corresponding to a position of the captured image using a GPS (Global Positioning System), and transmitting image information including the position information and the captured image;
in a service providing center, receiving the image information, detecting the position information and the image from the received image information, and storing the image based on the position information by an area;
in a second communication terminal, generating and transmitting an image service request signal for requesting a specific area image of the stored images;
in the service providing center, upon reception of the image service request signal requesting the specific area image of the stored images, transmitting the corresponding specific area image; and
in the second communication terminal, receiving and displaying the image from the service providing center in response to the image service request signal.

11. A method for providing an image service using a telematics system, the method comprising:
in a first communication terminal, capturing an image using a camera, generating position information corresponding to a position of the captured image using a GPS (Global Positioning System), and transmitting image information including the position information and the captured image;
in a service providing center, receiving the image information, detecting the position information and the image from the received image information, and storing the image based on the position information by an area;
in a second communication terminal, generating and transmitting an image service request signal;
in the service providing center, upon reception of the image service request signal, transmitting an image area information input request signal for requesting area information of a service-desired image;
in the second communication terminal, transmitting the area information in response to the image area information input request signal;
in the service providing center, transmitting an image list of an area corresponding to the area information to the second communication terminal;
in the second communication terminal, receiving the image list, selecting one image from the image list, and transmitting an image selection signal; and
in the service providing center, receiving the image selection signal, and transmitting an image corresponding to the received image selection signal.
